(19) United States
(12) Patent Application Publication
(10) Pub. No.: US 2005/0050072 A1
(43) Pub. Date: Mar. 3, 2005

(54) Highly parallel tree search architecture for multi-user detection

(75) Inventors: Benjamin John Widdup, Glenwood (AU); Graeme Kenneth Woodward, Eastwood (AU); Geoff Scott Knagge, Parramatta (AU)

Correspondence Address: WILLIAMS, MORGAN & AMERSON/LUCENT, 10333 RICHMOND, SUITE 1100, HOUSTON, TX, 77042, US

(73) Assignee: Lucent Technologies, Inc.

(21) Appl. No.: 10/654,207

(22) Filed: Sep. 3, 2003

(51) Int. Cl. G06F 7/00; G06F 17/00

(52) U.S. Cl. 707/100; 707/101

(57) ABSTRACT

A method for performing a tree search is provided. A set of candidates is identified and then interim and final characteristics associated with each of the candidates are produced by a plurality of parallel tasks. These interim and final characteristics are examined, and each candidate that has at least one of the interim and final characteristic exceeding at least one preselected setpoint is removed from the set of candidates. Candidates with only interim results that do not exceed the preselected setpoint are selected for continued processing. Candidates with a final characteristic falling below the preselected setpoint are assembled into a heap. The process repeats until all of the partial candidates have had their final characteristic determined or no partial candidates remain.

### BACKGROUND OF THE INVENTION

1. Field of the Invention

This invention relates generally to telecommunications, and, more particularly, to detection in wireless communications.

2. Description of the Related Art

In the field of wireless telecommunications, such as cellular telephony, a system typically includes a plurality of base stations distributed within an area to be serviced by the system. Various users within the area, fixed or mobile, may then access the system and, thus, other interconnected telecommunications systems, via one or more of the base stations. Typically, a user maintains communications with the system as the user passes through an area by communicating with one and then another base station, as the user moves. The user may communicate with the closest base station, the base station with the strongest signal, the base station with a capacity sufficient to accept communications, etc.

Commonly, each base station is constructed to process a plurality of communications sessions with a plurality of users in parallel. In this way, the number of base stations may be limited while still providing communications capabilities to a large number of simultaneous users. Typically, each user is generally free to transmit information to the base station substantially unregulated. Moreover, each user is free to transmit any of a wide variety of information from a known universe of symbols. That is, multiple users may transmit a complex array of information to the base station at the same time. Further, the information transmitted from each user may be subjected to unique conditions, such as noise, attenuation, etc. Given the variety of signals that may be sent and the variety of complicating factors that may be applied to these signals, the base station has a daunting task of accurately and quickly determining what each user has transmitted. The base station's ability to handle this task limits the total number of users that may be accommodated.

The present invention is directed to overcoming, or at least reducing, the effects of one or more of the problems set forth above.

### SUMMARY OF THE INVENTION

In one aspect of the instant invention, a method is provided for performing a tree search. The method comprises identifying a set of candidates and producing interim and final characteristics associated with each of the candidates by a plurality of parallel tasks. Each candidate is removed from the set of candidates in response to determining that at least one of the interim and final characteristics exceeds at least one preselected setpoint. A set of final candidates is built from the set of candidates having a final characteristic falling below the preselected setpoint.

In another aspect of the instant invention, A computer readable program storage device is encoded with instructions that, when executed by a computer, performs a method for searching a tree. The method comprises identifying a set of candidates and producing interim and final characteristics associated with each of the candidates by a plurality of parallel tasks. Each candidate is removed from the set of candidates in response to determining that at least one of the interim and final characteristics exceeds at least one preselected setpoint. A set of final candidates is built from the set of candidates having a final characteristic falling below the preselected setpoint.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a communications system, in accordance with one embodiment of the present invention;

FIG. 2 depicts a block diagram of one embodiment of a base station and two users in the communications system of FIG. 1;

FIG. 3 illustrates a basic tree structure;

FIG. 4 is a functional block diagram of an exemplary architecture of a tree search engine;

FIG. 5 illustrates a binary tree structure; and

FIG. 7 illustrates a block diagram of one exemplary embodiment of the processing elements from FIG. 4

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

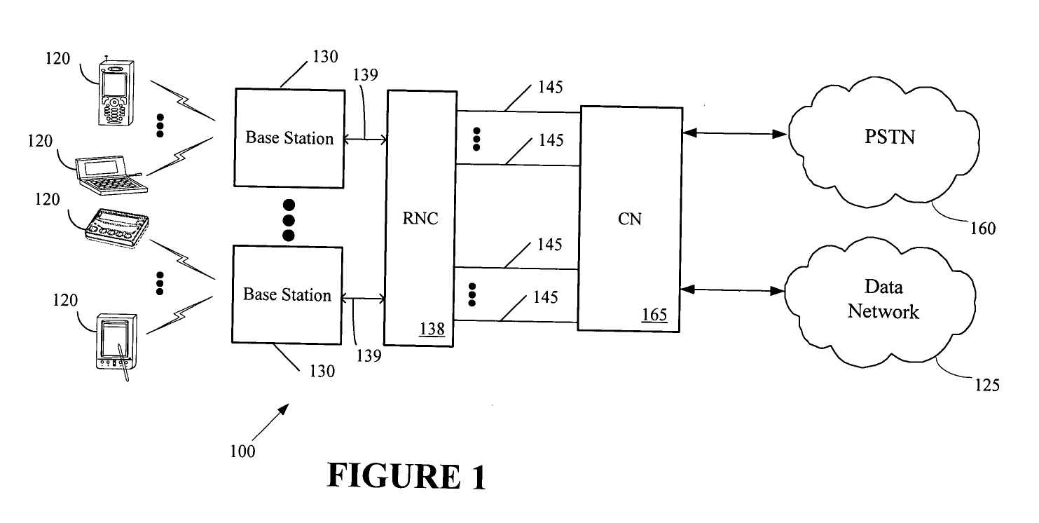

Turning now to the drawings, and specifically referring to FIG. 1, a communications system 100 is illustrated, in accordance with one embodiment of the present invention. For illustrative purposes, the communications system 100 of FIG. 1 is a Universal Mobile Telephone System (UMTS), although it should be understood that the present invention may be applicable to other systems beyond data and/or voice communication. The communications system 100 allows one or more users 120 to communicate with a data network 125, such as the Internet, through one or more base stations 130. The user 120 may take the form of any of a variety of devices, including cellular phones, personal digital assistants (PDAs), laptop computers, digital pagers, wireless cards, and any other devices capable of accessing the data network 125 through the base station 130.

In one embodiment, a plurality of the base stations 130 may be coupled to a Radio Network Controller (RNC) 138 by one or more connections 139, such as T1/EI lines or circuits, ATM circuits, cables, optical digital subscriber lines (DSLs), and the like. Although only two RNCs 138 are illustrated, those skilled in the art will appreciate that a plurality of RNCs 138 may be utilized to interface with a large number of the base stations 130. Generally, the RNC 138 operates to control and coordinate the base stations 130 to which it is connected. The RNC 138 of FIG. 1 generally provides replication, communications, runtime, and system management services. The RNC 138, in the illustrated embodiment handles calling processing functions, such as setting and terminating a call path and is capable of determining a data transmission rate on the forward and/or reverse link for each of the users 120 and for each sector supported by each of the base stations 130.

The RNC 138 is, in turn, coupled to a Core Network (CN) 165 via a connection 145, which may take on any of a variety of forms, such as T1/E1 lines or circuits, ATM circuits, cables, optical digital subscriber lines (DSLs), and the like. Generally the CN 140 operates as an interface to a data network 125 and/or to a public telephone system (PSTN) 160. The CN 140 performs a variety of functions and operations, such as user authentication, however, a detailed description of the structure and operation of the CN 140 is not necessary to an understanding and appreciation of the instant invention. Accordingly, to avoid unnecessarily obfuscating the instant invention, further details of the CN 140 are not presented herein.

The data network 125 may be a packet-switched data network, such as a data network according to the Internet Protocol (IP). One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 125 may also include other types of packet-based data networks in further embodiments. Examples of such other packet-based data networks include Asynchronous Transfer Mode (ATM), Frame Relay networks, and the like.

As utilized herein, a “data network” may refer to one or more communication networks, channels, links, or paths, and systems or devices (such as routers) used to route data over such networks, channels, links, or paths.

Thus, those skilled in the art will appreciate that the communications system 100 facilitates communications between the users 120 and the data network 125. It should be understood, however, that the configuration of the communications system 100 of FIG. 1 is exemplary in nature, and that fewer or additional components may be employed in other embodiments of the communications system 100 without departing from the spirit and skill of the instant invention. For example, system 100 may employ routers (not shown) between the base stations 130 and the RNC 138 or CN 165.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

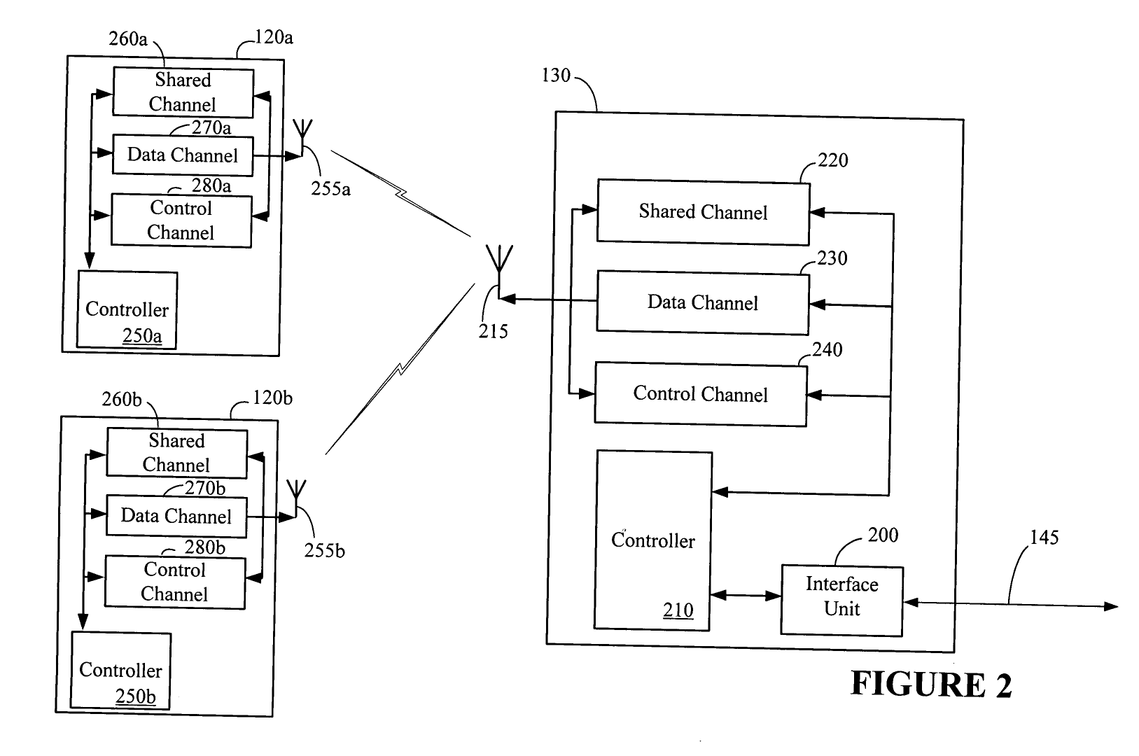

Referring now to FIG. 2, a block diagram of one embodiment of a functional structure associated with an exemplary base station 130 and a pair of the users 120a, 120b is shown. The base station 130 includes an interface unit 200, a controller 210, an antenna 215 and a plurality of types of channels: a shared channel type 220, a data channel type 230, and a control channel type 240. The interface unit 200, in the illustrated embodiment, controls the flow of information between the base station 130 and the RNC 138 (see FIG. 1). The controller 210 generally operates to control both the transmission and reception of data and control signals over the antenna 215 and the plurality of channels 220, 230, 240 and to communicate at least portions of the received information to the RNC 138 via the interface unit 200.

In the illustrated embodiment, the users 120a, 120b are substantially similar at least at a functional block diagram level. Those skilled in the art will appreciate that while the users 120a, 120b are illustrated as being functionally similar in the instant embodiment, substantial variations may occur without departing from the spirit and scope of the instant invention. For purposes of describing the operation of the instant invention it is useful to describe the users 120a, 120b as being functionally similar. Thus, for the instant embodiment, the structure and operation of the users 120a, 120b is discussed herein without reference to the “a” and “b” suffixes on their element numbers, such that a description of the operation of the user 120 applies to both of the users 120a, 120b.

The user 120 shares certain functional attributes with the base station 130. For example, the user 120 includes a controller 250, an antenna 255 and a plurality of channel types: a shared channel type 260, a data channel type 270, and a control channel type 280. The controller 250 generally operates to control both the transmission and reception of data and control signals over the antenna 255 and the plurality of channel types 260, 270, 280.

Normally, the channel types 260, 270, 280 in the user 120 communicate with the corresponding channel types 220, 230, 240 in the base station 130. Under the operation of the controllers 210, 250 the channel types 220, 260; 230, 270; 240, 280 are used to effect communications from the user 120 to the base station 130. For example, in one embodiment of the instant invention, the base station 130 receives information from the users 120a, 120b over one or more of the channels 220, 230, 240 and performs a predefined search technique for identifying the information or symbols that the users 120a, 120b have transmitted. As discussed above, the accuracy and speed of the search technique can have a significant impact on the number of users 120 that a base station 130 can support.

Consider a multi-user system with M users and N different symbols that may be received from each user, which can be represented by:
y=Hs+n (1)
where y is an N×1 vector of received symbols, H is an N×M complex matrix representing both a channel and spreading associated with the transmitted symbol, s is an M×1 vector representing the transmitted symbols, and n is an M×1 vector representing additive white Gaussian noise. This is, of course, a simplified model in which users are assumed to be synchronous. The simplified model is useful for illustrating the principles of the instant invention, but is not intended to limit the spirit or scope of the instant invention.

Estimating the transmitted symbols may begin with finding an unconstrained maximum likelihood solution that will become the center of a search sphere for a subsequent constrained maximum likelihood solution. The unconstrained maximum likelihood solution is given by a Moore-Penrose pseudo-inverse:
ŝ=(H^{H}H)⁻¹H^{H}y (2)

The constrained maximum likelihood solution forces the result onto a lattice, A of permissible solutions. The constrained maximum likelihood solution is then:

$$\begin{matrix}{s}_{m l} = arg {min}_{s ∈ Λ} {‖ y - Hs ‖}^{2} \\ = arg {min}_{s ∈ Λ} {( y - Hs )}^{H} ( y - Hs )\end{matrix} \qquad ( 3 )$$

It has been shown that solving equation (3) is equivalent to solving:

$${s}_{ml} = arg {min}_{s ∈ Λ} {( s - \hat{s} )}^{H} {H}^{H} H ( s - \hat{s} ) \qquad ( 4 )$$

where ŝ is the unconstrained maximum likelihood solution as defined in equation (2).

Using a Cholesky or QR decomposition, an upper triangular matrix U may be obtained such that H^{H}H=U^{H}U with non-negative diagonal elements. This allows equation (4) to be simplified to:

$${s}_{ml} = arg {min}_{s ∈ Λ} {( s - \hat{s} )}^{H} {U}^{H} U ( s - \hat{s} ) \qquad ( 5 )$$

Rather than consider all points (equivalent to a brute-force search), it may be useful to only consider the set of points lying within a hyper-sphere of radius r, centered at ŝ.
(s−ŝ)^{H}U^{H}U(s−ŝ)≦r² (6)
Or equivalently,

$${\sum }_{i = M}^{1} {\vert {\sum }_{j = i}^{M} {u}_{ij} ( {s}_{j} - {\hat{s}}_{j} ) \vert}^{2} \leq {r}^{2} \qquad ( 7 )$$

where uᵢⱼ represents elements of the upper triangular matrix U. The diagonal elements of U are real and non-negative, whereas the off-diagonal elements may be complex. Consideration of this subset of points is described as a tree search, where each level of the tree corresponds to a row of U in equation (5).

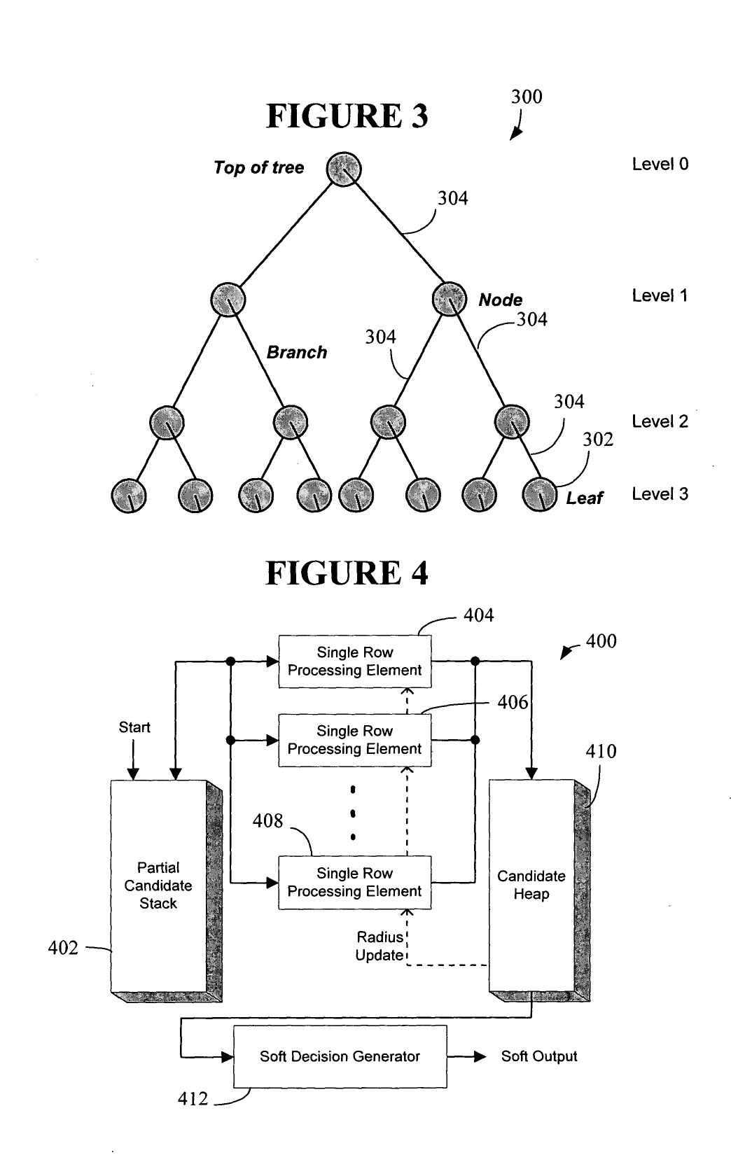

An exemplary binary tree 300 of depth 4 is shown in FIG. 3. The binary tree 300 has 2^{M}−1 nodes where M is the depth of the tree 300 (e.g., 15 nodes in the exemplary case of the 4 deep binary tree of FIG. 3). A leaf 302 is defined as a node on the last row or level of the tree 300, with no nodes below it. Non-leaf nodes have branches 304 to their children, and each branch has an associated cost known as the branch cost. As the search engine descends into the tree 300, a cost is computed at each level (and the cost at each level corresponds to the incremental cost at each row of equation (5)).

By exploiting the triangular shape of U, the total cost of equation (5) can be computed incrementally, row-by-row in U from the bottom up. Should the cost at any stage (or row) ever exceed a threshold (called the radius), the current solution may be discarded and any other solutions that match the partial solution which was discarded may also be discarded (solutions that are below the current node in the tree always have a higher cost than the current node because, by virtue of the norm in equation (7), the incremental cost is always positive). This allows one to efficiently prune significant parts of the tree 300 or search space during the search process, saving both computation time and power. It may also be desirable to reorder the rows of H, s and y so as to search the “easier to demodulate” layers first as described in equation (7), but the instant invention is not so limited.

An argument that simply minimizes equation (5) will produce the constrained maximum likelihood solution, but it gives no soft information or confidence about the decision. In order to generate soft information, a set of constrained points centered around S, a sphere center, may be considered.

By examining the set of solutions that lie within the hyper-sphere with radius less than r, it is possible to approximate a posteriori probability (APP) with suitable accuracy. How many points need to be considered in this set is examined subsequently herein. From a set of the L most-likely solutions that lie within the hyper-sphere, a list sphere detector can generate soft information by examining the bit changes and the relative costs of these bit changes.

FIG. 4 shows a block level diagram of one embodiment of an architecture of a tree search engine 400. Those skilled in the art will appreciate that the tree search engine 400 of FIG. 4 may be accomplished in hardware, software or a combination thereof and may be located in one or more convenient locations in the system 100 or some other system. In one embodiment, the tree search engine 400 is located, at least partially, in the base station 130 and is configured to be executed by the controller 210. Generally, the tree search engine 400 comprises a partial candidate stack 402, one or more processing elements 404, 406, 408, a heap 410 and a soft decision generator 412.

The stack 402 is responsible for storing partial candidates, (where a partial candidate is an incomplete candidate, and a candidate is a solution to equation (6) with an associated cost). The processing elements 404, 406, 408 are each capable of computing one outer summation term of equation (7). The heap 410 is used to store the leading candidates, and the soft decision generator 412 uses information from the leading candidates stored in the heap 410 to produce a soft output signal. In one embodiment, the leading candidates are those candidates with the lowest costs, i.e., those closest to the sphere center.

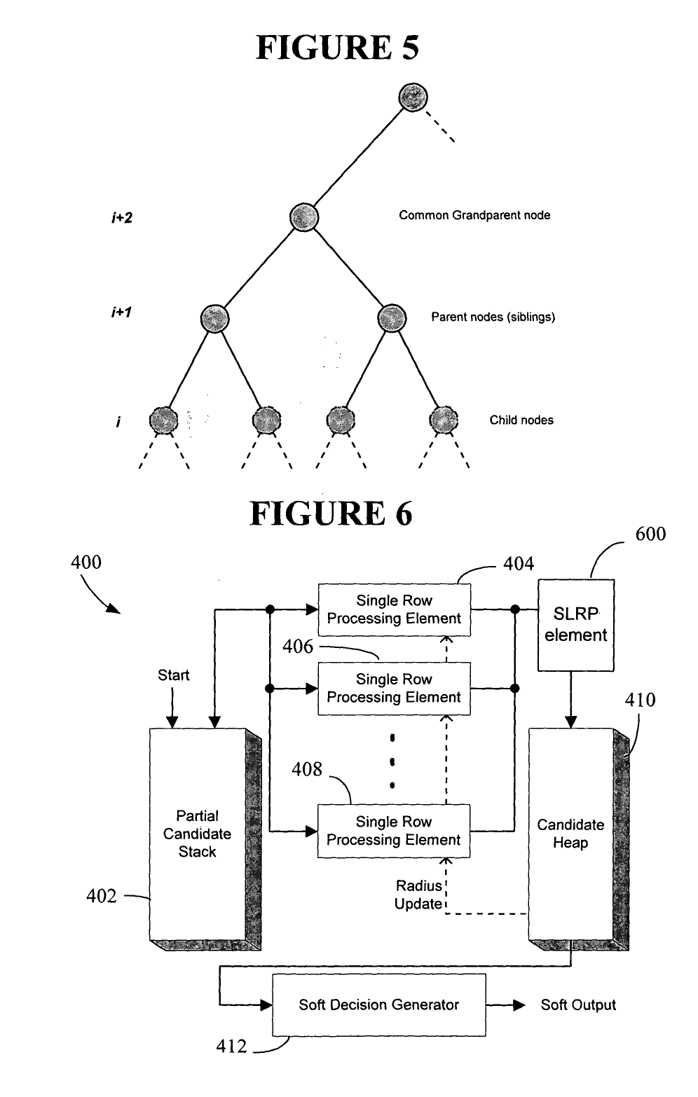

The processing elements 404, 406, 408 comprise the main processing engine of the tree search engine 400. These processing elements 404, 406, 408 compute the cost of the child nodes (level i in FIG. 5) below the parent (level i+1 in FIG. 5). To improve computational efficiency, each of the processing elements 404, 406, 408 can process the cost of all children with a common grandparent in parallel. This parallelism exploits the commonality in the calculation between closely related parent nodes. Referring to equation (6), the common part of the expression for the i^{th} row is:

$${\sum }_{j = i + 2}^{M} {u}_{ij} ( {s}_{j} - {\hat{s}}_{j} ) \qquad ( 8 )$$

Each call to one of the processing elements 404, 406, 408 results in i being decremented. The processing elements 404, 406, 408 are described in more detail below.

The number of multiplication operations performed in the processing elements 404, 406, 408 can be significantly reduced by pre-computing U·ŝ. Since the vector s contains only ±1 entries (BPSK) or ±1 and ±j entries (QPSK), equation (7), may be simplified to the following expression which contains selective add/subtract and squaring operations.

$${\sum }_{i = M}^{1} {\vert {\sum }_{j = i}^{M} ( {u}_{ij} {s}_{j} - {u}_{ij} {\hat{s}}_{j} ) \vert}^{2} \leq {r}^{2} \qquad ( 9 )$$

where uᵢⱼŝⱼ are the pre-computed elements of U·ŝ, and sⱼε±1.

The stack 402 is used to store partial candidate solutions. In one embodiment, the stack 402 operates in a last-in, first-out (LIFO) mode, allowing the search to progress down the tree 300 in such a way as to compute the leaves from left to right across the tree 300. Alternatively, sorting entries in the stack 402 provides a more efficient way to search the tree 300 because nodes of most interest are visited first. A sorted stack is not strictly a stack because entries are not removed in a LIFO fashion, but for ease of understanding this sorted buffer will continue to be referred to as a stack.

Entries are sorted as they are added to the stack 402, limiting the memory required for the stack 402 to a small, well defined size, and simultaneously providing a mechanism to follow the branches with minimum incremental cost first, i.e., paths of highest interest first. Insertion sorting is efficient because entries added to the stack 402 do not generally move far during the insertion sort as discussed later. Those skilled in the art will appreciate that other sort techniques may be employed without departing from the spirit and scope of the instant invention.

Examining paths in order of interest means that the most likely leaves are examined first, which reduces processing in two ways. First, it means fewer leaves are added to the heap 410 and then discarded at a later time, and second, because lower cost candidates are found earlier, it allows the size of the search sphere to be dynamically reduced more quickly, resulting in more aggressive radius reduction, which in turn translates to fewer nodes visited. An added advantage of maintaining a sorted stack is that a meaningful result can be obtained even in cases where time constraints prevent the tree search from being completed. The stack 402 is common to all of the processing elements 404, 406, 408, and thus, provides a mechanism for redistributing the processing load between the processing elements 404, 406, 408.

Generally, the stack 402 stores several types of data, including depth in tree (i), cost to date for each node that will be processed in parallel at the next level (i), and the partial candidate. In one embodiment, it may be useful to sort the information in the stack 402 based on the depth first and the cost-to-date, such that next stack entry to be popped is the one with the greatest depth and lowest cost-to-date.

Since the stack 402 is sorted, there can be a maximum of M−2 entries on the stack 402 per processing module where M is the depth of the tree. Therefore, maximum stack length is bounded by the expression p.(M−2), where p is the number of parallel processors. Being bounded, the stack 402 can be readily built in hardware.

Stack sorting is not as expensive as a general sort because entries added to the stack 402 are typically at increased depths and therefore do not generally move very far during the insertion sort. The sorting process need not become a bottleneck. Should sorting time be a problem, a smart stack controller can allow a processing element to pop an entry off the stack 402 before the insertion sort has found the correct position for the entry it is adding.

Alternatively, the load associated with sorting may be eased by performing only a partial sort during times of high activity. Upon detecting a period of high activity, a smart stack controller could stop using the second sort key and rely solely on the first sort key. In the instant embodiment, partial sorting based on only the first key would result in the stack entries being sorted by depth (guaranteeing maximum stack size is bounded) but not by cost. Thus some “out-of-order” processing would occur, which may not be ideal, but this is permissible because the tree may be searched in any order. On the other hand, it may be useful in some embodiments to sort by cost, as under some circumstances the order in which the tree is searched may be improved.

Stack entries with a high relative cost can be removed early; that is, before their cost exceeds the current radius. If the partial cost is scaled up to the depth of the tree and the entries that exceed the radius by a certain amount are discarded, the operation count may be reduced by a factor of at least about 2 without significant effect on the performance of the sphere detector. The following formulae with linear scaling have been used in a 16 user system to predictively prune stack entries with good results.

TABLE 1
Predictive stack pruning levels.

| Depth | | |
|---|---|---|
| (i) | Test | Comment |
| 1-3 | None | Too early to |
| | | discard |
| 4-8 | $\frac{cost \cdot 16}{i} > 1.5 \cdot r$ | Conservative test |
| 9-15 | $\frac{cost \cdot 16}{i} > 1.25 \cdot r$ | More aggressive test |
| 16 | Not applicable | Leaf node |

Constants 1.5 and 1.25 are selected because multiplication by either value can be achieved with a single shift-add operation. Division by i can be avoided by either precomputing 16/i or multiplying both sides of the expression by i. Other values for predictive stack pruning may be selected without departing from the spirit and scope of the instant invention.

The selection criteria shown in Table 1 is used to prune the entries in the partial candidate stack 402, assuming that the matrix U is well balanced, that is, all diagonal elements are approximately equal. Should there be a wide range in the magnitude of diagonal elements of U, the matrix may be either normalized before performing detection or a non-linear scaling (based upon the magnitude of the diagonal elements) may be used to prune the stack. Predictive stack pruning based on the cost is performed on the newly calculated stack entry before the entry is added to the stack.

Using the heap 410 to store the list of the leading candidates (along with their cost) allows the largest cost-to-date candidate to be quickly found and is more efficient than keeping either a sorted or unsorted list. However, alternative constructs of the heap 410 may prove beneficial in certain circumstances. In practice, storing a fixed number of candidates is sufficient for generating bit a posteriori probabilities. The number of candidates that are required depends upon the quality of soft information desired and the number of users, M.

Assume a fixed amount of storage for L candidate solutions. As candidate solutions with cost less than radius are generated, they are added to a heap. Once the heap is full, further candidates are added by discarding the L^{th} highest cost candidate to date (top of heap) and replacing it with the new candidate. The heap controller then filters the new solution down to its appropriate level to maintain the heap rule. At the same time, the sphere radius is updated with the cost of the highest cost candidate in the new set (located at the heap top). This radius reduction strategy ensures that the L best candidates are kept and that additional power is not wasted computing candidates with cost greater than the L^{th} largest.

The heap rule is
cost(└x/2┘)≧cost(x) (10)
where 2≦x≦L is the index to the heap and └·┘ denotes round down.

Entries can be added to the heap in less than O(log₂ L) time. During the early part of the detection process, while the heap is not full, the heap building process may be simplified by building the heap from bottom up. The first L/2 entries are added in leaf positions relative to the final heap and can be added in unit time. The next L/4 entries can be added in O(1) time (entries are filtered down by a maximum of 1 level), and so on, up the rows of the heap with the last entry being added in O(log₂ L) time. Thus, the heap can be built in significantly less than O(log₂ L) time. The data structure does not obey the properties of a heap until it is full, i.e. it is not a heap whilst it is being built. However this is not a problem in this application because the data may be extracted from the heap in arbitrary order.

The output of the tree search engine (or list sphere detector) is a soft decision for each user's bit, with the sign representing the decision and the magnitude representing the reliability. Generally, a log likelihood ratio (LLR) of probabilities is used:

$$LLR = ln \frac{P ( + 1 \vert y )}{P ( - 1 \vert y )} \qquad ( 11 )$$

In a spherical list detector, these probabilities can be determined directly from the cost information known about the candidates. For a system containing AWGN,

$$P ( s \vert y ) = \frac{1}{\sqrt{2 π {σ}^{2}}} {ⅇ}^{\frac{- cost}{2 {σ}^{2}}} \qquad ( 12 )$$

where cost is cost of the candidate s and is a squared Euclidian distance measure.

The probability of a “1” being transmitted is equal to the sum of the probabilities of all of the combinations containing a “1” for that given user k. If A is the set of 2^{M} possible solutions for M users, then this is represented as

$$\begin{matrix}P ( {s}_{k} = 1 \vert y ) = \frac{1}{\sqrt{2 π {σ}^{2}}} {\sum }_{s ∈ Λ , {s}_{k} = 1} {ⅇ}^{\frac{- cost}{2 {σ}^{2}}} & ( 13 ) \\ P ( {s}_{k} = - 1 \vert y ) = \frac{1}{\sqrt{2 π {σ}^{2}}} {\sum }_{s ∈ Λ , {s}_{k} = - 1} {ⅇ}^{\frac{- cost}{2 {σ}^{2}}} & ( 14 )\end{matrix}$$

If only the costs of the best L solutions are known, then the others may be estimated from the knowledge that their cost is at least as high as that of our worst known point (current radius). This value can then be substituted in place of the unknown costs. Alternatively, these unknown results may be ignored completely, since their contribution is likely to be relatively small.

The soft outputs can then be determined by:

$$\begin{matrix}{LLR}_{k} = ln \frac{P ( {s}_{k} = 1 \vert y )}{P ( {s}_{k} = - 1 \vert y )} \\ = ln ( P ( {s}_{k} = 1 \vert y ) ) - ln ( P ( {s}_{k} = - 1 \vert y ) )\end{matrix} \qquad ( 15 )$$

The softbit is thus obtained by performing a logsum of the probabilities for a received 1 and −1 (equations (13) and (14) respectively). The

$$\frac{1}{\sqrt{2 π {σ}^{2}}}$$

term cancels out and 2σ² can be estimated without significantly affecting the performance of most decoders. Equation (15) can then be computed with the well-known logsum operation.

A hard decision can be determined from the soft outputs by recording the sign of the output, with the magnitude representing the relative confidence of the decision.

Since the soft decision generator 412 can extract the candidates from the heap in any order, reading data out of the heap 410 can be completed in linear time. Furthermore, since the time to generate the soft data is faster than the tree search, this step can be pipelined and computed in parallel with the initial calculations for the next block.

The value initially chosen for the radius may have significant impact on the operation of the tree search. If the radius is too small, very few, if any, solutions will lie within this radius and the search may fail or give poor results. On the other hand, if the initial radius is too large, numerous candidates will be generated and later discarded, requiring significant computational overhead. One choice for the initial radius that guarantees a full candidate list is to set the initial radius to infinity.
r₀=∞ (16)

Radius reduction comes into effect as soon as the heap fills, reducing the search sphere and amount of computation required.

In a real-time system, it may be useful to terminate the search before it comes to its natural completion. A meaningful result may still be obtained because the sorted stack ensures the paths of highest interest are normally searched first.

Higher degrees of parallelism within a processing element are possible. For example, one could compute the cost of all related nodes with a common great-great-grandparent. However, simulations to date have shown that computing the children for nodes with a common great-grandparent in parallel within a processing element results in an acceptable trade-off between power and speed for systems with less than about 30 users.

Multiple processing elements operating in parallel can speed up the search process. The processing elements share a common stack 402 and a common heap 410. Simultaneous access to either the stack 402 or heap 410 may be handled with arbitration.

When the number of parallel processing elements 404, 406, 408 becomes large, access to the sorted stack 402 may become a bottleneck, such that the addition of further processing elements 404, 406, 408 may not significantly increase throughput. Adding a specialist last-row processing element 600 to the architecture, as shown in FIG. 6, may mitigate the problem.

The specialist last-row processing element 600 in one embodiment is highly parallel and may be configured to process equation (9) for the case when i=1 (i is decremented from M down to 1 and 1 corresponds to computations for the last level of the tree). When a processing element 404, 406, 408 reaches the penultimate row (i=2), instead of pushing the partial candidates back onto the stack 402, this partial candidate is delivered to the specialist processing element 600 for accelerated last row processing.

The specialist last-row processing element 600 may significantly reduce the load on the partial candidate stack (up to 50% in some applications), and to a lesser degree on the processing elements 404, 406, 408. Most of the activity in the stack 402 occurs with respect to nodes located near the end of the tree. Thus, since the specialist last-row processing element 600 is invoked in the region of high activity for the stack 402, the stack 402 receives substantial benefit.

The specialist last-row processing element 600 has additional parallel logic (compared with the general processing elements 404, 406, 408) making it larger and faster than the general processing elements 404, 406, 408. In one embodiment, the specialist last-row processing element 600 calculates 4 leaf costs in as many cycles with pipelining. By generating leaf costs at least as fast as the heap 410 is able to accept candidates, the likelihood of a bottleneck is greatly reduced. Although the general processing elements 404, 406, 408 have arbitrated access to the last-row processing element 600, they would on average not have to wait any longer for access as compared with access to the heap 410. It is similar to a general row-processing element in that it computes the cost of all children for a common grandparent.

With the specialist last-row processing element 600 in place, predictive stack pruning is no longer available on the penultimate row. This suggests that additional specialist row processing elements on other rows is less worthwhile with diminishing returns. Also the hardware requirement for additional specialist processing elements grows exponentially.

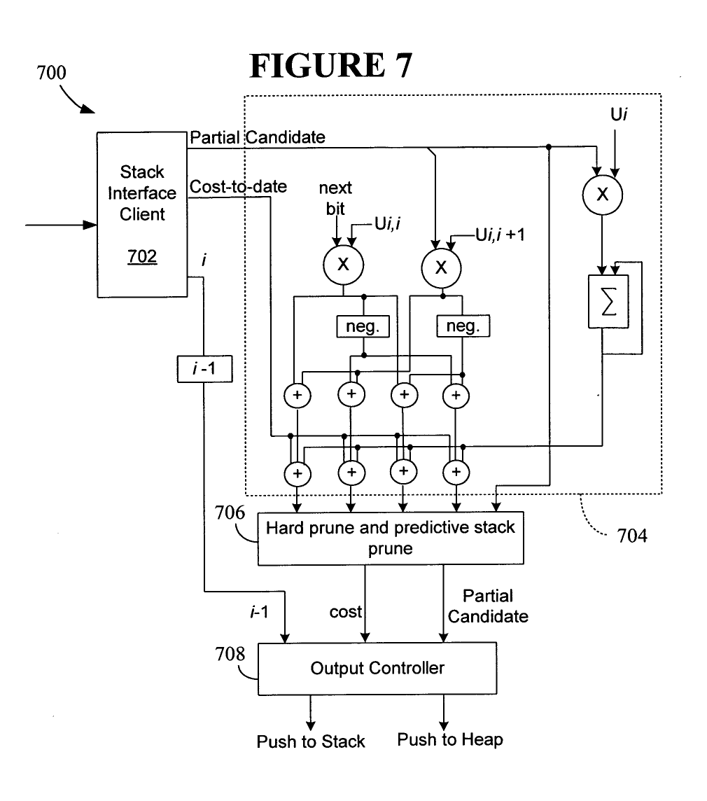

FIG. 7 illustrates a block diagram of one exemplary embodiment of a processing element 700 that may be employed as any of the processing elements 404, 406, 408 from FIG. 4. Generally, the processing element 700 calculates the costs of 4 children for two (closely related) nodes in parallel. A stack interface client 702 communicates with the stack 402 and is responsible for retrieving a partial candidate from the stack 402. The stack 402 supplies the following information when requested by the stack interface client 702: (a) the row (i) of the matrix that is equivalent to the index into the tree, as shown in FIG. 5; (b) cost-to-date for the partial solutions. Because the processing element 700 processes two nodes in parallel, there are two costs-to-date for the two partial solutions that are bundled together in the stack; and (c) the partial candidate. This is the partial solution to date.

An arithmetic unit 704 receives the information retrieved by the stack interface unit 702 and uses the information to compute one element of the outer sum of equation (7). The arithmetic unit 704 may be accomplished in hardware, software or a combination thereof. One exemplary representation of the arithmetic unit 704 is shown in FIG. 7 and is formed from a plurality of appropriately interconnected multipliers, adders and negation blocks. The partial costs are calculated for the four children in two pairs. These pairs are added to the two previous costs-to-date obtained from the heap 410. At the end of the process, the arithmetic unit has successfully calculated a cost for the 4 child nodes.

A pruning block 706 performs at least two tests on the 4 child nodes to determine whether to keep them or discard the newly calculated nodes. Hard pruning involves testing to see whether the new cost exceeds the current radius and discarding the nodes if the cost threshold has been exceeded. A second test involves applying equations shown in Table I to determine if predictive pruning is appropriate.

Accordingly, up to 4 new nodes may be discovered at one level further into the tree. These nodes are again partial candidate solutions, but are now closer to being (complete) candidates). An output controller 708 bundles the pairs of nodes and returns them to the stack 402, unless the nodes are leaf nodes or penultimate nodes in the case of specialist last-row processing being in place. If the nodes are leaf nodes, the output controller 708 delivers the candidate (which is equivalent to a leaf node) to the heap 410 instead.

Multiple iterations around the “stack 402—processing element 700—back to stack 402” loop build up successive elements of the outer summation term of equation 7 until the calculation is complete (i.e., when a leaf node is reached). The engine 400 is started by pushing a null partial candidate (corresponding to the top of the tree) onto the stack. The search process is complete when the stack 402 is empty and all of the processing units 404, 406, 408 are idle.

Those skilled in the art will appreciate that the various system layers, routines, or modules illustrated in the various embodiments herein may be executable control units (such as the controllers 210, 250 (see FIG. 2)). The controllers 210, 250 may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the controllers 210, 250 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

1. A method for performing a tree search, comprising:
identifying a set of candidates;
producing interim and final characteristics associated with each of the candidates by a plurality of parallel tasks;
removing each candidate from the set of candidates in response to determining that at least one of the interim and final characteristics exceeds at least one preselected setpoint; and
building a set of final candidates from the set of candidates having a final characteristic falling below the preselected setpoint.

2. A method, as set forth in claim 1, further comprising forming a set of partial candidates by placing the candidates having an interim characteristic falling below the preselected setpoint into a stack.

3. A method, as set forth in claim 2, further comprising:
producing final characteristics associated with each of the partial candidates by a plurality of parallel tasks;
removing each partial candidate from the stack in response to determining that the final characteristic exceeds at least one preselected setpoint; and
building the set of final candidates from the set of partial candidates having a final characteristic falling below the preselected setpoint.

4. A method, as set forth in claim 2, further comprising sorting the set of partial candidates.

5. A method, as set forth in claim 4, wherein sorting the set of partial candidates further comprises sorting the set of partial candidates based upon depth.

6. A method, as set forth in claim 4, wherein sorting the identified set of candidates further comprises sorting the identified set of candidates based upon cost.

7. A method, as set forth in claim 4, wherein sorting the set of partial candidates further comprises sorting the set of partial candidates based upon depth and the interim characteristic.

8. A method, as set forth in claim 1, further comprising adjusting the first preselected setpoint based on at least one of the identified characteristics associated with the final candidates in the set of final candidates.

9. A method, as set forth in claim 8, wherein adjusting the first preselected setpoint further comprises setting the first preselected setpoint to the largest characteristic associated with the final candidates.

10. A method, as set forth in claim 9, wherein setting the first preselected setpoint to the largest characteristic further comprises setting the first preselected setpoint to the largest characteristic associated with the final candidates in the set in response to the set being filled.

11. A method, as set forth in claim 1, wherein building a set of final candidates from the set of candidates having a final characteristic falling below the preselected setpoint further comprises building a heap of final candidates from the set of candidates having a final characteristic falling below the preselected setpoint.

12. A method, as set forth in claim 11, wherein building the heap of final candidates from the set of candidates having a final characteristic falling below the preselected setpoint further comprising building the heap beginning at the bottom.

13. A method, as set forth in claim 1, further comprising generating soft information using the set of final candidates.

14. An apparatus for performing a tree search, comprising:
means for identifying a set of candidates;
means for producing interim and final characteristics associated with each of the candidates by a plurality of parallel tasks;
means for removing each candidate from the set of candidates in response to determining that at least one of the interim and final characteristics exceeds at least one preselected setpoint; and
means for building a set of final candidates from the set of candidates having a final characteristic falling below the preselected setpoint.

15. A computer readable program storage device encoded with instructions that, when executed by a computer, performs a method for searching a tree, comprising:
identifying a set of candidates;
producing interim and final characteristics associated with each of the candidates by a plurality of parallel tasks;
removing each candidate from the set of candidates in response to determining that at least one of the interim and final characteristics exceeds at least one preselected setpoint; and
building a set of final candidates from the set of candidates having a final characteristic falling below the preselected setpoint.

16. A computer readable program storage device, as set forth in claim 15, further comprising forming a set of partial candidates by placing the candidates having an interim characteristic falling below the preselected setpoint into a stack.

17. A computer readable program storage device, as set forth in claim 16, further comprising:
producing final characteristics associated with each of the partial candidates by a plurality of parallel tasks;
removing each partial candidate from the stack in response to determining that the final characteristic exceeds at least one preselected setpoint; and
building the set of final candidates from the set of partial candidates having a final characteristic falling below the preselected setpoint.

18. A computer readable program storage device, as set forth in claim 16, further comprising sorting the set of partial candidates.

19. A computer readable program storage device, as set forth in claim 18, wherein sorting the set of partial candidates further comprises sorting the set of partial candidates based upon depth.

20. A computer readable program storage device, as set forth in claim 18, wherein sorting the identified set of candidates further comprises sorting the identified set of candidates based upon cost.

21. A computer readable program storage device, as set forth in claim 18, wherein sorting the set of partial candidates further comprises sorting the set of partial candidates based upon depth and the interim characteristic.

22. A computer readable program storage device, as set forth in claim 15, further comprising adjusting the first preselected setpoint based on at least one of the identified characteristics associated with the final candidates in the set of final candidates.

23. A computer readable program storage device, as set forth in claim 22, wherein adjusting the first preselected setpoint further comprises setting the first preselected setpoint to the largest characteristic associated with the final candidates.

24. A computer readable program storage device, as set forth in claim 23, wherein setting the first preselected setpoint to the largest characteristic further comprises setting the first preselected setpoint to the largest characteristic associated with the final candidates in the set in response to the set being filled.

25. A computer readable program storage device, as set forth in claim 15, wherein building a set of final candidates from the set of candidates having a final characteristic falling below the preselected setpoint further comprises building a heap of final candidates from the set of candidates having a final characteristic falling below the preselected setpoint.

26. A computer readable program storage device, as set forth in claim 25, wherein building the heap of final candidates from the set of candidates having a final characteristic falling below the preselected setpoint further comprising building the heap beginning at the bottom.

27. A computer readable program storage device, as set forth in claim 15, further comprising generating soft information using the set of final candidates.

28. An apparatus adapted to perform a tree search, comprising:
a stack adapted to receive a set of candidates;
a plurality of parallel processing elements coupled to the stack and adapted to produce interim and final characteristics associated with each of the candidates;
means for removing each candidate from the set of candidates in response to determining that at least one of the interim and final characteristics exceeds at least one preselected setpoint; and
a heap coupled to the processing elements and adapted to receive a set of final candidates from the set of candidates having a final characteristic falling below the preselected setpoint.
